(19) United States
(12) Patent Application Publication
(10) Pub. No.: US 2026/0179649 A1
(43) Pub. Date: Jun. 25, 2026

(54) FLEXURE OF SUSPENSION FOR HARD DISK DRIVE AND METHOD OF MANUFACTURING THE FLEXURE

(71) Applicant: NHK SPRING CO., LTD., Yokohama-shi (JP)

(72) Inventor: Tetsuya UEDA, Yokohama-shi (JP)

(73) Assignee: NHK SPRING CO., LTD., Yokohama-shi (JP)

(21) Appl. No.: 19/426,090

(22) Filed: Dec. 19, 2025

(30) Foreign Application Priority Data
Dec. 24, 2024 (JP) 2024-227649

(51) Int. Cl. G11B 5/48

(52) U.S. Cl. CPC G11B 5/4833

(57) ABSTRACT

A flexure of a suspension for a hard disk device according to one embodiment is a flexure overlaid on a load beam provided in the suspension of the hard disk device. The flexure includes a metal base having a first surface facing the load beam and a second surface on an opposite side to the first surface. The metal base includes a first limiter and a second limiter, and a first opposing portion and a second opposing portion facing the first limiter and the second limiter, respectively. The first limiter and the second limiters have respective control portions inclined relative to a longitudinal direction of the metal base, which face the first opposing portion and the second opposing portion, respectively, with a gap therebetween in a thickness direction of the metal base.

### CROSS-REFERENCE TO RELATED APPLICATIONS

This application is based upon and claims the benefit of priority from prior Japanese Patent Application No. 2024-227649, filed December 24, 2024, the entire contents of which are incorporated herein by reference.

### BACKGROUND OF THE INVENTION

### 1. Field of the Invention

The present invention relates to a flexure of a suspension for hard disk devices and a method for manufacturing the flexure.

### 2. Description of the Related Art

Hard disk drives (HDDs) are used in data processors such as personal computers and the like. The hard disk drives include a magnetic disk rotating around a spindle, a carriage pivoting around a pivot shaft and the like. The carriage includes an actuator arm and pivots around the pivot shaft in a width direction of a track of the disk by a positioning motor such as a voice coil motor.

The above-described arm has a suspension for a hard disk drive (hereinafter simply referred to as the suspension) attached thereto. The suspension includes a base plate connected to the arm, a load beam, and a flexure disposed along the load beam. A slider, which constitutes the magnetic head, is provided at the gimbal portion formed near the distal end of the flexure.

To the slider, an element (transducer) is provided for performing access operations such as the reading or writing of data. The load beam, flexure, slider and the like constitute the head gimbal assembly.

To accommodate higher disk recording densities, it is necessary to further miniaturize the head gimbal assembly and also enable positioning of the slider relative to the disk recording surface at higher precision.

There is a demand for increasing the storage capacity in hard disk drives to match improvements in recording density, and the number of magnetic disks within a hard disk drive (so-called multi-platter configuration) is being increased. Therefore, it is required to make suspensions thinner.

Further, when a hard disk device receives an external shock, it is necessary to suppress excessive deformation or damage to the suspension during load/unload operations of the suspension. Various proposals have been made for this purpose (for example, JP 2021-140843 A).

However, even considering the proposals in the above patent document, there remains considerable room for improvement regarding the limiter structure.

### BRIEF SUMMARY OF THE INVENTION

One objective of the present invention is to provide a flexure of a suspension for a hard disk drive, which can suppress degradation in reliability, and a method for manufacturing such a flexure.

A flexure of a suspension for a hard disk device according to one embodiment is a flexure overlaid on a load beam provided in the suspension of the hard disk device. The flexure includes a metal base having a first surface facing the load beam and a second surface on an opposite side to the first surface. The metal base includes a first limiter and a second limiter arranged along a width direction of the metal base, and a first opposing portion and a second opposing portion facing the first limiter and the second limiter, respectively. The first limiter and the second limiters have respective control portions inclined relative to a longitudinal direction of the metal base in plan view, which face the first opposing portion and the second opposing portion, respectively, with a gap therebetween in a thickness direction of the metal base.

The metal base may further include a first base portion to which the first limiter and the second limiter are connected, and a second base portion provided at a tip end side relative to the first base portion along the longitudinal direction, to which the first opposing portion and the second opposing portion are connected. The control portion may face the first surface of the second base portion with a gap therebetween along the thickness direction. The control portions of the first limiter and the second limiter may be inclined such that they approach each other in plan view as a location thereof advances in the longitudinal direction.

The metal base may further include a first base portion to which the first opposing portion and the second opposing portion are connected, and a second base portion provided at a tip end side relative to the first base portion along the longitudinal direction, to which the first limiter and the second limiter are connected. The control portion may face the second surface of the first base portion with a gap therebetween along the thickness direction. The control portions of the first limiter and the second limiter may be inclined such that they are spaced apart further from each other in plan view as the location advances in the longitudinal direction.

Each of the respective distances along the thickness direction between the first limiter and the second limiter and the first opposing portion and the second opposing portion may be substantially constant along the longitudinal direction when viewed in the width direction. The control portions may have respective side portions substantially parallel to the first opposing portion and the second opposing portion, respectively. The metal base may further include a third base portion provided at a tip end side relative to the second base portion, connected to the second base portion, and fixed to the load beam.

A method of manufacturing a flexure according to one embodiment comprising placing a workpiece, having a first extending portion and a second extending portion extending in the width direction for the first limiter and the second limiter, respectively, into a first mold having a first corner portion and a second corner portion inclined relative to the longitudinal direction in plan view; fixing the workpiece by sandwiching it between the first mold and the second mold, and relatively moving the third mold with respect to the first mold and the second mold to bend the first extending portion and the second extending portion by the first corner portion and the second corner portion. The placing includes adjusting the positions of the first corner and second corner relative to the first extending portion and the second extending portion, respectively, in the width direction. The adjusting may include moving the workpiece relative to the first mold in the longitudinal direction.

According to the above-described configuration, it is possible to provide a flexure of a suspension for a hard disk device, which can suppress the degradation in reliability, and a method for manufacturing the flexure.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view showing an example of a hard disk device.

FIG. 2 is a schematic cross-sectional view showing a part of the hard disk device.

FIG. 3 is a schematic plan view of a suspension according to the first embodiment.

FIG. 4 is a schematic perspective view of a metal base in the first embodiment.

FIG. 5 is a schematic plan view of the metal base in the first embodiment.

FIG. 6 is another schematic plan view of the metal base in the first embodiment.

FIG. 7 is a schematic side view of the metal base in the first embodiment.

FIG. 8 is a flowchart showing a process of manufacturing a limiter of a flexure.

FIG. 9 is a schematic plan view showing the metal base before the limiter is formed.

FIG. 10 is a schematic diagram showing the apparatus for manufacturing the flexure.

FIG. 11A is a diagram illustrating an example of a method for adjusting a position of a bend line in the second direction.

FIG. 11B is a diagram illustrating another example of the method for adjusting the position of the bend line in the second direction.

FIG. 11C is a diagram illustrating still another example of the method for adjusting the position of the bend line in the second direction.

FIG. 12 is a schematic plan view showing a metal base of a flexure according to a comparative example.

FIG. 13 is a schematic plan view showing a metal base of a flexure according to the second embodiment.

FIG. 14 is a schematic side view showing the metal base of the flexure according to the second embodiment.

FIG. 15 is a schematic plan view showing the metal base of the flexure according to the second embodiment.

FIG. 16 is a schematic plan view showing a metal base of a flexure according to the third embodiment.

FIG. 17 is a schematic plan view showing the metal base of the flexure according to the third embodiment.

FIG. 18 is a schematic plan view showing a metal base of a flexure in the fourth embodiment.

FIG. 19 is a schematic plan view showing the metal base of the flexure in the fourth embodiment.

### DETAILED DESCRIPTION OF THE INVENTION

The embodiments of the present invention will now be described below with reference to the accompanying drawings. To make the explanation more clearly, the drawings may schematically represent the size, shape, etc., of each part differently from the actual implementation.

### First Embodiment

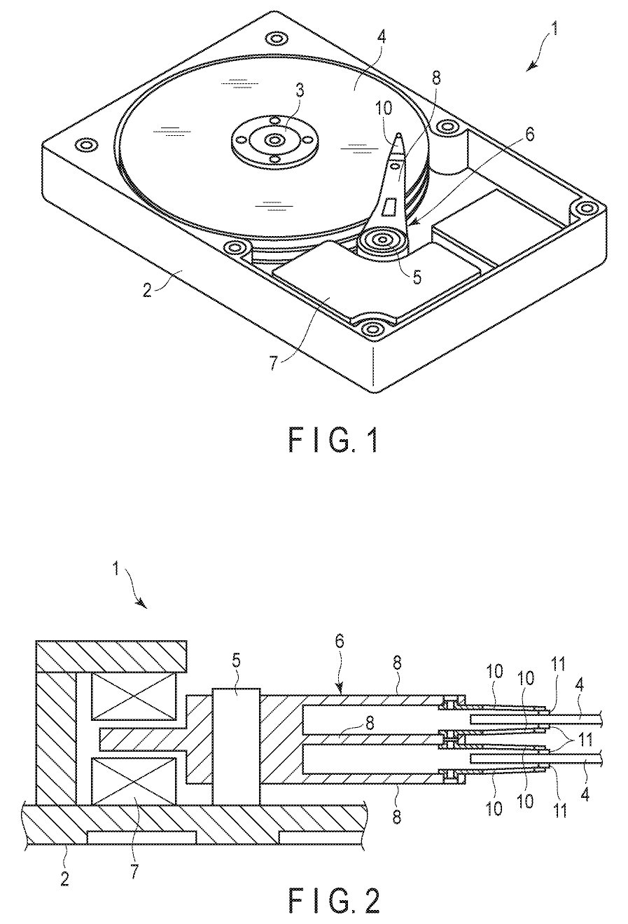

FIG. 1 is a schematic perspective view showing an example of a hard disk device 1 (HDD). In the example shown in FIG. 1, the hard disk device 1 comprises a case 2, a plurality of magnetic disks (hereinafter simply referred to as disks 4) rotating around a spindle 3, a carriage 6 pivotable around a pivot axis 5, and a positioning motor (voice coil motor) 7 for driving the carriage 6. The case 2 is sealed by a cover (not shown).

FIG. 2 is a schematic cross-sectional view showing a part of the hard disk device 1. As shown in FIG. 2, the carriage 6 is provided with a plurality (for example, three) of arms 8. The number of arms 8 provided on the carriage 6 is not limited to that of the above-described example.

At the distal end portion of each of the arms 8, a suspension for hard disk device (hereinafter referred to as a suspension 10) is mounted. Further, at the distal end portion of each suspension 10, a slider 11, which constitutes a magnetic head, is provided.

When a disk 4 is rotated at high speed, air flows between the disk 4 and the slider 11, thereby creating an air bearing. When the carriage 6 is pivoted by the positioning motor 7, the suspension 10 moves in a radial direction of the disk 4, and thus the slider 11 moves to the desired track on the disk 4.

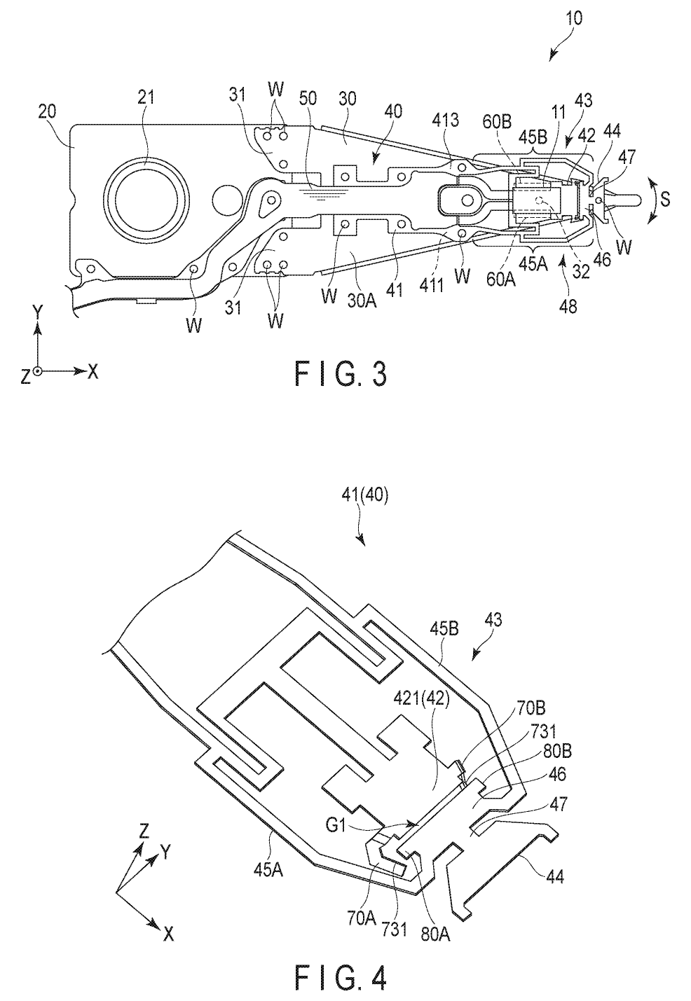

FIG. 3 is a schematic plan view of the suspension 10 according to this embodiment. The suspension 10 comprises a base plate 20 connected to the respective arm 8 (shown in FIG. 2), a load beam 30, and a flexure 40.

Here, from FIG. 3 on, an X axis, Y axis, and Z axis mutually orthogonal to each other are illustrated. The direction along the X axis is defined as a first direction X, the direction along the Y-axis is defined as a second direction Y, and the direction along the Z-axis is defined as a third direction Z. Viewing each element parallel to the third direction Z is in some cases referred to as a plan view.

Here, the first direction X corresponds to the longitudinal direction of the suspension 10, base plate 20, load beam 30, and flexure 40. In the first direction X, the side where the slider constituting the magnetic head is mounted, with reference to the base plate 20, may be referred to as a tip or tip side.

Further, the second direction Y corresponds to the width direction of the suspension 10, base plate 20, load beam 30, and flexure 40, whereas the third direction Z corresponds to the thickness direction of the suspension 10, base plate 20, load beam 30, and flexure 40. Hereinafter, the length along the third direction Z may be referred to as the thickness. Furthermore, a sway direction S, indicated by an arc-shaped arrow, is defined near the tip of the load beam 30.

The base plate 20 is formed, for example, of a metal material, such as stainless steel. The base plate 20 has a cylindrical boss portion 21 for connecting to the arm 8 (shown in FIG. 2).

The load beam 30 is formed from a metallic material, such as stainless steel. The thickness of the load beam 30 is, for example, 30 to 80 μm. The load beam 30 has a tapered shape narrowing toward its tip.

As shown in FIG. 3, the load beam 30 is connected to the base plate 20 at multiple weld points W, for example, by spot welding using a laser. Specifically, the load beam 30 is elastically supported on the base plate 20 via a pair of spring members 31 that include the multiple weld points W. The load beam 30 has a surface 30A on which the flexure 40 is disposed.

The flexure 40 is disposed along the base plate 20 and the load beam 30. The flexure 40 is overlaid on the surface 30A of the load beam 30. Further, a part of the flexure 40 extends rearward beyond the base plate 20.

The flexure 40 comprises a metal base 41 and a wiring portion 50 overlaid on the metal base 41. The metal base 41 is formed, for example, from a thin stainless steel plate. The thickness of the metal base 41 is less than the thickness of the load beam 30. The thickness of the metal base 41 is, for example, 15 to 20 μm.

The metal base 41 is fixed to the base plate 20 and the load beam 30 at a plurality of weld points W, for example, by spot welding using a laser. The metal base 41 has a surface 411 facing the surface 30A of the load beam 30 and a surface 413 on an opposite side to the surface 411. The surface 411 faces a direction opposite to the third direction Z, while the surface 413 faces the third direction Z. The surface 413 corresponds to the surface where the wiring portion 50 is disposed.

The wiring portion 50 includes a base insulating layer, a conductor layer overlaid on the base insulating layer, and a cover insulating layer overlaid on the conductor layer. The conductor layer includes, for example, wiring lines for reading operations and wiring lines for writing operations. These multiple wiring lines are covered by the cover insulating layer.

The metal base 41 further includes a tongue portion 42, a frame portion 43, and a fixation portion 44 near the tip of the suspension 10. The tongue portion 42, frame portion 43, and fixation portion 44 are all parts of the metal base 41, and their respective outlines are formed, for example, by etching.

The tongue portion 42, frame portion 43, and fixation portion 44 each have the surfaces 411 and 413 described above. Each of the surfaces 411 and 413 is, for example, an unetched surface (rolled surface).

The center of the tongue portion 42 in the second direction Y approximately coincides with the center of the fixation portion 44 in the second direction Y. The centers of the tongue portion 42 and the fixation portion 44 in the second direction Y approximately coincide with the center of the suspension 10 in the second direction Y.

A slider 11, which constitutes a magnetic head, is mounted on a part of the tongue portion 42. The tongue portion 42 includes a portion overlapping the slider 11 and a portion in its vicinity. In FIG. 3, the slider 11 is shown with a dashed line. At the tip of the slider 11, an element capable of converting magnetic signals to electrical signals and vice versa, such as an MR element, is provided.

The wiring portion 50 is electrically connected to the element on the slider 11 via terminals for the slider 11. Note that the terminals for the slider 11 are omitted in each figure for simplicity. These elements perform access operations such as writing or reading data to or from the disk 4 (shown in FIG. 2). The slider 11, load beam 30, flexure 40, and other members constitute a head gimbal assembly.

The frame portion 43 is disposed to surround the tongue portion 42. The frame portion 43 includes outriggers 45A and 45B and a connection portion 46. The outriggers 45A and 45B are disposed on respective sides of the tongue portion 42 along the second direction Y. The outrigger 45A and outrigger 45B are connected by the connection portion 46 at a position further on the tip side than the tongue portion 42.

The fixation portion 44 is provided at a position further on the tip side than the tongue portion 42 and the connection portion 46 in the first direction X. The tongue portion 42, the connection portion 46, and the fixation portion 44 are arranged in this order along the first direction X. The metal base 41 is fixed to the load beam 30 at the fixation portion 44 by a weld point W.

The fixation portion 44 is connected to the connection portion 46 in the first direction X via an intermediate portion 47. The width of the intermediate portion 47 in the second direction Y is less than the width of the connection portion 46 and the fixation portion 44 in the second direction Y.

The load beam 30 has a dimple (shown in dashed lines in FIG. 3) formed to protrude toward the tongue portion 42. The tip of the dimple 32 is in contact with the surface 411 in the tongue portion 42.

The tongue portion 42 is formed to swing about the tip of the dimple 32, thereby enabling desired gimbal motion. The gimbal portion 48 is constituted by the tongue portion 42, the outriggers 45A and 45B, the dimple 32, and the like.

On the gimbal portion 48, actuators 60A and 60B are mounted. The actuators 60A and 60B have the function of pivoting the tongue section 42 in the sway direction S. The actuators 60A and 60B are, for example, piezoelectric elements, which are formed from a material such as lead zirconate titanate (PZT).

The actuators 60A and 60B are disposed on the surface 411 so as to be spaced apart from each other along the second direction Y. Further, the actuators 60A and 60B, metal base 41, and slider 11 are arranged in this order along the third direction Z. The actuators 60A and 60B are each fixed to the tongue portion 42 using an adhesive or the like. The outriggers 45A and 45B are disposed on an outer side beyond the actuators 60A and 60B, respectively.

Focusing now on the vicinity of the tip of the flexure 40, the metal base 41 in this embodiment will be described. Note that the following figures primarily show a portion of the tip side of the metal base 41.

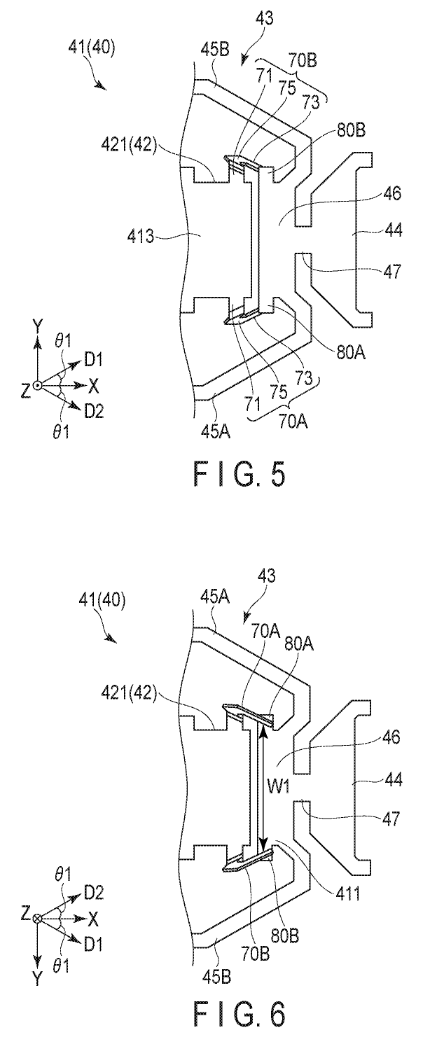

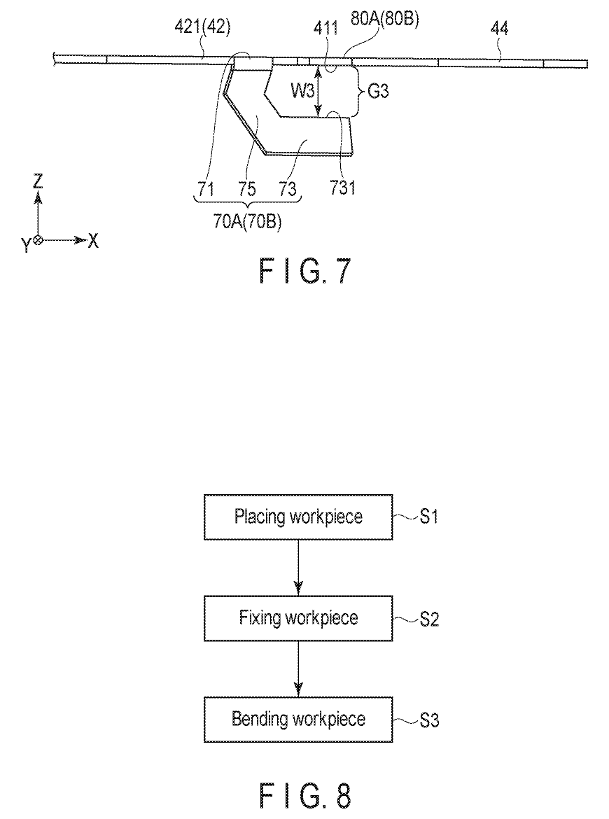

FIG. 4 is a schematic perspective view of the metal base 41 in this embodiment. FIGS. 5 and 6 are each a schematic plan view of the metal base 41 in this embodiment. FIG. 7 is a schematic side view of the metal base 41 in this embodiment. FIG. 6 shows the metal base 41 viewed from the opposite direction to that of FIG. 5. FIG. 7 shows the metal base 41 viewed in the second direction Y, in which the outrigger 45A is omitted from the illustration.

As shown in FIG. 4, the metal base 41 has a tongue portion 42, a frame portion 43, and a fixation portion 44. As shown in FIG. 4, the tongue portion 42 has a base portion 421 located on a tip side further from the portion where the slider 11 (shown in FIG. 3) is mounted.

The base portion 421 is disposed between the slider 11 and the connection portion 46 along the first direction X. In this embodiment, the base portion 421 corresponds to the portion of the tongue portion 42, which does not overlap the slider 11.

The connection portion 46 is not connected to the base portion 421. Between the base portion 421 and the connection portion 46 along the first direction X, a gap G1 is formed. The gap G1 is formed along the second direction Y.

The connection portion 46 has a shape elongated along the second direction Y. The width of the connection portion 46 along the second direction Y is, for example, approximately equal to the width of the base portion 421 along the second direction Y. Further, the width of the connection portion 46 along the first direction X is less than, for example, the width of the base portion 421 along the first direction X. The intermediate portion 47 extends in the first direction X from the central portion of the connection portion 46.

The metal base 41 further includes limiters 70A and 70B and opposing portions 80A and 80B facing the limiters 70A and 70B, respectively. In this embodiment, the limiters 70A and 70B are connected to the base portion 421, and the opposing portions 80A and 80B are connected to the connection portion 46. In this case, in the third direction Z, the limiters 70A and 70B and the opposing portions 80A and 80B are arranged in this order.

Specifically, the limiters 70A and 70B are connected to respective ends of the base portion 421 along the second direction Y, and the opposing portions 80A and 80B are connected to respective ends of the connection portion 46 along the second direction Y. The opposing portions 80A and 80B are formed to be integrated with, for example, the connection portion 46.

The limiters 70A and 70B are arranged along the second direction Y. Each of the limiters 70A and 70B is formed, for example, by bending a part of the base section 421. The limiter 70A has a line-symmetrical shape with respect to the limiter 70B, relative to a virtual straight line extending along the first direction X.

As shown in FIG. 5, each of the limiters 70A and 70B includes a portion 71, a portion 73, and a portion 75. The portion 71, portion 73, and portion 75 are formed, for example, to be integrated with each other. Each of the portions 71, 73, and 75 has a surface 411 and a surface 413.

The portion 71 is connected to the base portion 421. As shown in FIG. 5, the portion 71 of the limiter 70A extends from the base portion 421 in a direction opposite to the second direction Y, whereas the portion 71 of the limiter 70B extends from the base portion 421 in the second direction Y.

The portion 73, as shown in FIG. 5, is inclined relative to the first direction X in plan view. Specifically, the portion 73 of the limiter 70A extends in a direction D1 which intersects the first direction X at an acute angle (for example, angle θ1) counterclockwise. On the other hand, the portion 73 of the limiter 70B extends in a direction D2 which intersects the first direction X at an acute angle (for example, angle θ1) clockwise. The angle θ1 is, for example, from 5 degrees to 45 degrees. In one example, the angle θ1 is 25 degrees. Note that the angles of the directions D1 and D2 are equal to each other, that is, the angle θ1, but the angles of the directions D1 and D2 may as well be different from each other.

The portions 73 of the limiters 70A and 70B are inclined such that, in plan view, they approach each other as the locations thereof advance in the first direction X, as shown in FIG. 6. The distance W1 along the second direction Y between two portions 73 adjacent to each other decreases as the location advances in the first direction X.

Focusing on the opposing portions 80A and 80B, as shown in FIG. 7, the portion 73 of the limiter 70A faces the opposing portion 80A, and the portion 73 of the limiter 70B faces the opposing portion 80B. The portions 73 of the limiters 70A and 70B face the opposing portions 80A and 80B respectively with a gap G3 therebetween along the third direction Z relative to the respective surfaces 411 of the opposing portions 80A and 80B.

Here, the state of “facing” includes not only cases where no other elements are disposed between the respective elements, but also cases where other elements are disposed therebetween. Further, the state of “facing” includes not only cases where the respective elements are parallel to each other, but also cases where one element is inclined relative to the other element.

The portions 73 of the limiters 70A and 70B are provided, for example, substantially parallel to the opposing portions 80A and 80B, respectively. The portions 73 of the limiters 70A and 70B include respective edge portions 731 facing the opposing portions 80A and 80B, respectively, as shown in FIG. 7.

In plan view, the edge portion 731 of the limiter 70A extends along the direction D1, and the edge portion 731 of the limiter 70B extends along the direction D2. Specifically, the edge portions 731 of the portions 73 of the limiters 70A and 70B are provided substantially parallel to the respective surfaces 411 of the opposing portions 80A and 80B.

Here, the state of being “substantially parallel” includes cases where the portion 73 (edge portion 731) is inclined within a range of 0 to 10 degrees relative to the respective one of the opposing portions 80A and 80B. Further, the distance W3 between the edge portion 731 and the respective one of the opposing portions 80A and 80B along the third direction Z is substantially constant along the first direction X when viewed in the second direction Y. Here, the expression “substantially constant” also includes cases where the distance W3 changes slightly at positions in the first direction X.

The portion 75 connects the portion 71 and the portion 73 to each other. The portion 75 extends in the direction toward the load beam 30 (shown in FIG. 3). The portion 75 is configured, for example, such that the portion 73 is provided substantially parallel to the respective one of the opposing portions 80A and 80B. The portion 75 extends in a direction different from those of the portions 71 and 73. The shape of the portion 75 is not limited to that of the example illustrated. The portion 75 may as well be formed, for example, in a straight line or in an arc shape. Furthermore, the portion 73 may be directly connected to the portion 71.

Subsequently, an example of a method of manufacturing the flexure 40 will be described. The following explanation primarily focuses on the process for forming the limiters 70A and 70B of the metal base 41.

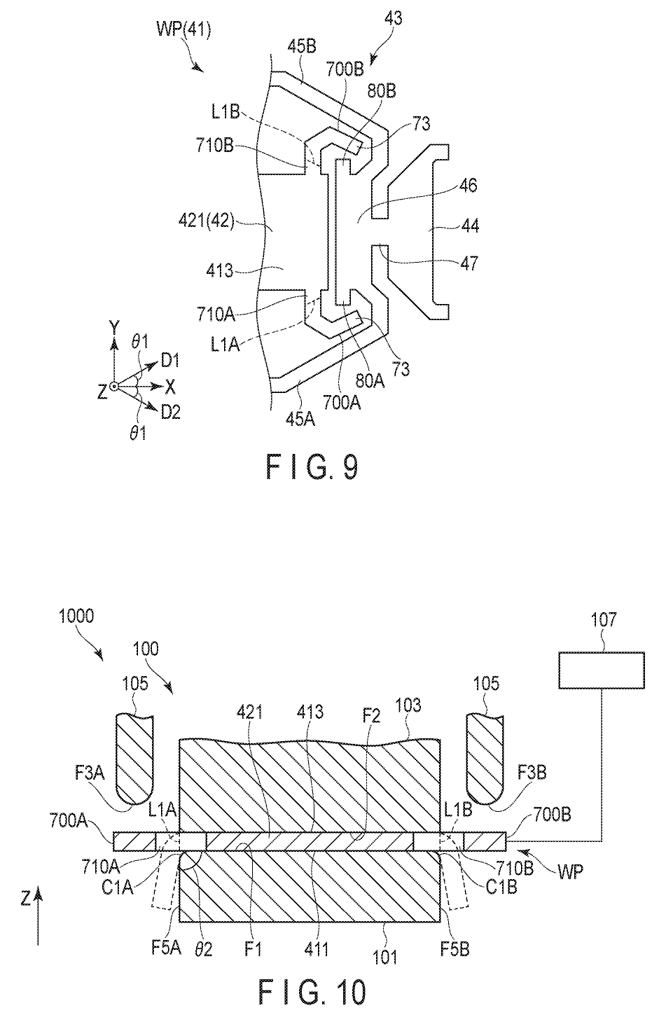

FIG. 8 is a flowchart showing the manufacturing process for the limiters 70A and 70B of the flexure 40. FIG. 9 is a schematic plan view showing the metal base 41 before the limiters 70A and 70B are formed.

Hereinafter, as shown in FIG. 9, the metal base 41 before the formation of the limiters 70A and 70B is referred to as a workpiece WP. The workpiece WP is connected to a frame (not shown), for example. On the frame, there may be only one workpiece WP provided or may be multiple workpieces WP provided in a chain-like manner. Further, the workpiece WP may not be provided on the frame.

Prior to steps S1 to S3 shown in FIG. 8, the above-described workpiece WP is prepared. The workpiece WP is formed through a processing step of forming a flexure blank by forming the wiring portion 50 on the metal base 41, followed by performing etching, and the like, and a processing step of mounting the actuators 60A and 60B. As shown in FIG. 9, the workpiece WP has extending portions 700A and 700B.

The extending portions 700A and 700B each include the portions 71, 73, and 75. The extending portions 700A and 700B extend from the base portion 421 in the second direction Y and in the direction opposite to the second direction Y, respectively. Specifically, the extending portion 700A includes a straight portion 710A extending in the direction opposite to the second direction Y, and the extending portion 700B includes a straight portion 710B extending in the second direction Y.

By bending the extending portions 700A and 700B at respective predetermined positions, the limiters 70A and 70B of the metal base 41 are formed. In FIG. 9, the positions where the extending portions 700A and 700B are to be bent, are indicated as bend lines L1A and L1B, respectively.

The line L1A extends along the direction D1, and the line L1B extends along the direction D2. Further, the portion 73 of the extending portion 700A extends along the direction D1, and the portion 73 of the extending portion 700B extends along the direction D2. That is, the lines L1A and L1B are parallel to the portions 73 of the extending portions 700A and 700B, respectively.

FIG. 10 is a schematic diagram showing a device 1000 of manufacturing the flexure 40. The manufacturing device 1000 comprises a mold 100. The mold 100 includes a die 101, a pad 103, and a punch 105. Although not shown, the manufacturing device 1000 may further include a mechanism for driving the pad 103 and the punch 105, a mechanism for transporting the workpiece WP to the mold 100, and the like. The mold 100 may further include other elements or may include other elements in place of the elements mentioned above.

First, the workpiece WP is placed on the surface F1 of the die 101 (step S1 in FIG. 8). The workpiece WP is appropriately positioned relative to the die 101 using jigs (for example, positioning pins, guides, and the like).

Next, the workpiece WP is fixed (step S2 in FIG. 8). Specifically, as shown in FIG. 10, the surface F1 of the die 101 supports the surface 411 of the workpiece WP, while the surface F2 of the pad 103 presses down on the surface 413 of the workpiece WP from above. Thus, the workpiece WP is sandwiched between the die 101 and the pad 103 and fixed therein.

At this point, at least part of the straight portions 710A and 710B of the extending portions 700A and 700B is not located between the die 101 and the pad 103. The portions of the straight portions 710A and 710B, which are located between the die 101 and the pad 103 correspond to the portions 71 of the limiters 70A and 70B, respectively.

Subsequently, the bending process for the extending portions 700A and 700B is executed (step S3 in FIG. 8). Here, the punch 105 is moved relative to the die 101 and the pad 103. For example, the punch 105 is lowered toward the extending portions 700A and 700B. In the example shown in FIG. 10, the state before the punch 105 is lowered is illustrated. Further, in the example shown in FIG. 10, the state where the extending portion 700A has been bent is indicated by dashed lines.

The punch 105 is lowered, for example, at a constant speed, and thus a predetermined force is applied to the extending portions 700A and 700B. The punch 105 has, for example, curved tip surfaces F3A and F3B. The tip surfaces F3A and F3B are brought into contact with the extending portions 700A and 700B, respectively, and slid over the surfaces 413 of the extending portions 700A and 700B, and they are bent along corner portions C1A and C1B of the die 101.

The extending portions 700A and 700B are bent to a predetermined angle. The lines L1A and L1B are formed according to the positions of the corner portions C1A and C1B, respectively. Note that the bending radii of the extending portions 700A and 700B are set appropriately based on the material, the thickness of the workpiece, and the target bending angle. The bending angle θ2 is, for example, 95 degrees or more and 115 degrees or less. The bending angle is the angle formed between the base portion 421 and the limiter 70A or 70B.

In FIG. 10, the extending portions 700A and 700B of the state after step S3 in FIG. 8 are indicated by dashed lines. Then, the punch 105 is raised, and thus the bending process of the extending portions 700A and 700B is completed. By performing the steps S1 to S3 described above, a flexure 40 as shown in FIG. 3 can be obtained.

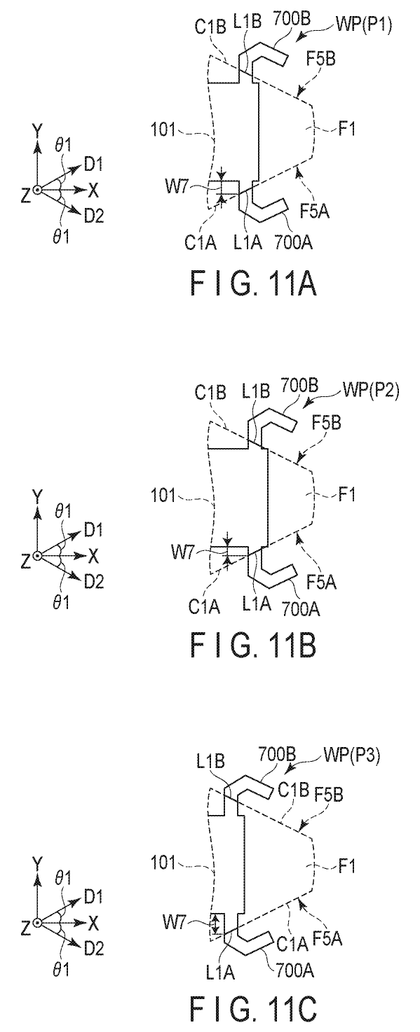

Subsequently, an example of a method for adjusting the positions of lines L1A and L1B in the second direction Y will be described. FIGS. 11A to 11C are diagrams each illustrating an example of the method for adjusting the positions of the lines L1A and L1B along the second direction Y.

The die 101 has corner portions C1A and C1B. As shown in FIG. 11A, in plan view, the corner portion C1A of the die 101 extends along the direction D1, and the corner portion C1B of the die 101 extends along the direction D2. The corner portions C1A and C1B are inclined such that they approach each other as the location progresses in the first direction X.

Further, the die 101 further includes side surfaces F5A and F5B connected to the corner portions C1A and C1B, respectively. The side surfaces F5A and F5B face directions opposite to each other. As in the case of the corner portions C1A and C1B, the side surfaces F5A and F5B are inclined relative to the first direction X in plan view. The side surfaces F5A and F5B extend along the directions D1 and D2, respectively.

The positions of the lines L1A and L1B in the second direction Y are changed, for example, by adjusting the positions of the corner portions C1A and C1B of the die 101 relative to the extending portions 700A and 700B in the second direction Y, respectively. Specifically, the position of the workpiece WP is moved relative to the die 101 along the first direction X. Thus, the positions of the corner portions C1A and C1B are changed along the second direction Y.

Here, the case where the workpiece WP is moved relative to the die 101 is assumed. The manufacturing device 1000 may further comprise an adjustment mechanism 107, as shown in FIG. 10. The adjustment mechanism 107 is configured, for example, to be able to move the workpiece WP relative to the die 101 in both the first direction X and the direction opposite to the first direction X. Note that the adjustment mechanism 107 may be configured as part of the transport mechanism for the workpiece WP or as a separate mechanism from the transport mechanism.

As described above, the corner portions C1A and C1B are inclined such that they approach each other in the first direction X. Here, the position of the workpiece WP relative to the die 101 in FIG. 11A is indicated as a first position P1.

For example, as shown in FIG. 11B, when the workpiece WP is moved from the first position P1 in the first direction X, the position of the workpiece WP is changed to a second position P2. In this case, compared to the first position P1, the position of the corner portion C1A in the extending portion 700A is moved in the direction opposite to the second direction Y, and the position of the corner portion C1B in the extending portion 700B is moved in the second direction Y.

Consequently, the positions of the lines L1A and L1B move in a direction approaching the central portion of the second direction Y. In this case, when step S3 of FIG. 8 is executed, the length W7 of the portion 71 is shortened as compared to that of the example in FIG. 11A. Focusing on the gap G3 (shown in FIG. 7), the distance W3 becomes larger as compared to that of the example in FIG. 11A.

Further, as shown in FIG. 11C, when the workpiece WP is moved from the first position P1 in the direction opposite to the first direction X, the position of the workpiece WP is changed to the third position P3. In this case, compared to the first position P1, the position of the corner portion C1A in the extending portion 700A is moved in the second direction Y, and the position of the corner portion C1B in the extending portion 700B is moved in the direction opposite to the second direction Y.

As a result, the positions of the lines L1A and L1B are moved in a direction away from the central portion of the second direction Y. In this case, when step S3 of FIG. 8 is executed, the length of the portion 71 becomes greater as compared to that of the example in FIG. 11A. Focusing on the gap G3 (shown in FIG. 7), the distance W3 becomes shorter as compared to that of the example in FIG. 11A.

As described above, by moving the position of the workpiece WP relative to the die 101 in the first direction X, the positions where the extending portions 700A and 700B are bent can be adjusted. In other words, by moving the position of the workpiece WP relative to the die 101 in the first direction X, the positions of the lines L1A, L1B in the second direction Y can be adjusted.

The limiters 70A and 70B suppress the tongue portion 42 from moving excessively far away from the dimple 32 or undergoing excessive gimbal motion when the suspension 10 receives an impact from outside. Specifically, as the portions 73 of the limiters 70A and 70B are brought into contact with the opposing portions 80A and 80B, respectively, the movement of the tongue portion 42 is suppressed. Consequently, the deformation or damage to the suspension 10 can be suppressed.

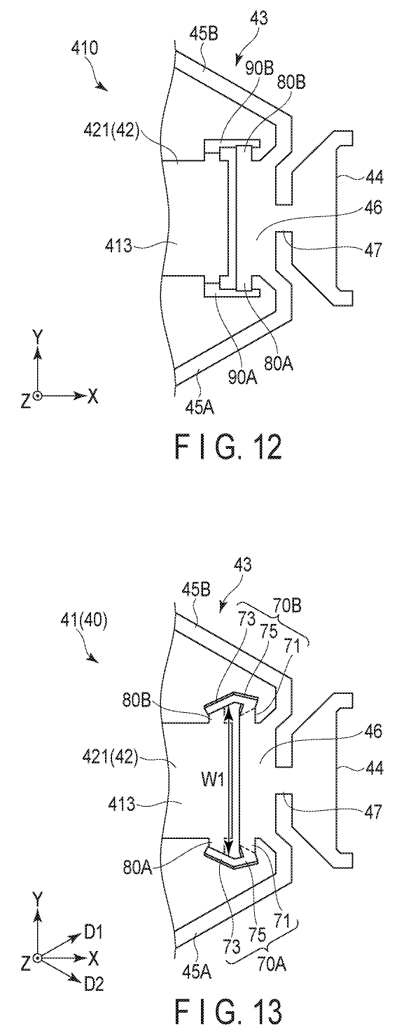

FIG. 12 is a schematic plan view showing a metal base 410 of a flexure according to a comparative example. The metal base 410 has limiters 90A and 90B. The limiters 90A and 90B have an approximately L-shaped configuration when viewed in the second direction Y. Portions 91 of the limiters 90A and 90B extend in the first direction X. In other words, the distance between two portions 91 adjacent to each other along the second direction Y is substantially constant in the first direction X. Focusing on the relationship with opposing portions 80A and 80B, the portions 73 intersect perpendicular to the opposing portions 80A and 80B, respectively, in plan view.

The space available for placing limiters to accommodate thinner suspensions is limited, and therefore the limiter size cannot be increased. Consequently, with the limiters in the comparative example, it is difficult to obtain the effect of suppressing the deformation of the suspension.

As in this embodiment, by inclining the portions 73 of the limiters 70A and 70B in plan view, the portions 73 can be inserted further inward between the opposing portions 80A and 80B. With this configuration, the engagement lengths of the limiters 70A and 70B with respect to the opposing portions 80A and 80B can be increased compared to those of the comparative example.

In this embodiment, the contact area between the limiters 70A and 70B and the opposing portions 80A and 80B can be made larger than that of the comparative example, and thus the function of the limiters 70A and 70B, that is, to suppress deformation can be reliably exhibited. As a result, the deformation of the suspension 10 can be more easily suppressed. Consequently, according to this embodiment, it is possible to suppress a decrease in the reliability of the hard disk device.

Further, by increasing the contact area with the opposing portions 80A and 80B compared to that of the comparative example, the force acting on the limiters 70A and 70B can be distributed over the entire area, thereby making it possible to suppress the deformation of the limiters 70A and 70B themselves.

Moreover, with the manufacturing method of this embodiment, the distance W3 can be adjusted by moving the position of the workpiece WP relative to the die 101. In other words, by relatively moving the position of the workpiece WP with respect to the die 101, the heights of the limiters 70A and 70B can be easily adjusted.

For example, by reducing the heights of the limiters 70A and 70B, the heights of the limiters 70A and 70B are less likely to affect the thickness of the suspension 10, thereby making it possible to adapt to the increase in the number of disks in the hard disk device.

Furthermore, with the manufacturing method of this embodiment, it is not necessary to prepare multiple molds in advance according to the distance W3. Therefore, according to this embodiment, the cost of manufacturing the metal base 41 can be reduced and the cost for the management of molds can be lowered.

Moreover, in this embodiment, the limiters 70A and 70B and the opposing portions 80A and 80B constitute the limiter structure. Here, the limiters 70A and 70B and opposing portions 80A and 80B are each a part of the metal base 41, and therefore the limiter structure can be easily formed. For example, it is easy to adjust the overlapping degree between the portions 73 of the limiters 70A and 70B and the opposing portions 80A and 80B.

When the limiter structure is formed by the load beam and the flexure, the limiter of the flexure must be engaged onto a part of the load beam during assembly. This operation may sometimes fail to engage properly or cause deformation.

With this embodiment, it is possible to form a limiter structure that is less susceptible to the effects of assembly precision between the load beam 30 and the flexure 40. In other words, according to this embodiment, the assembly of the flexure 40 and the load beam 30 can be facilitated.

With the flexure 40 configured as described above, and the suspension 10 comprising the flexure 40, a decline in reliability can be suppressed. Apart from the above, various other favorable effects can be obtained from this embodiment.

Next, other embodiments will be described. Note that in the other embodiments to be described below, components identical to those employed in the first embodiment described above may be assigned the same reference numerals as those in the first embodiment, and their detailed descriptions may be omitted or simplified.

### Second Embodiment

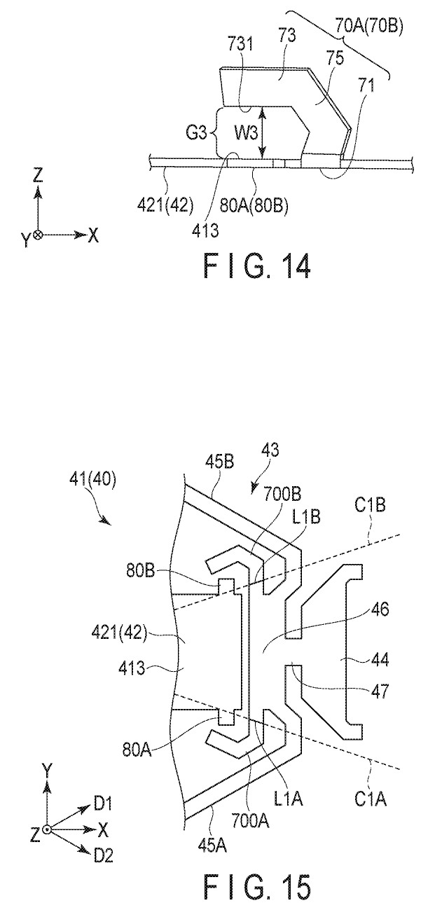

FIG. 13 is a schematic plan view showing a metal base 41 of a flexure 40 according to this embodiment. FIG. 14 is a schematic side view showing the metal base 41 of the flexure 40 according to this embodiment. FIG. 15 is a schematic plan view showing the metal base 41 of the flexure 40 according to this embodiment. FIG. 15 shows the state of the extending portions 700A and 700B before they are bent.

This embodiment is different from the first embodiment in that the limiters 70A and 70B are connected to the connection portion 46, and the opposing portions 80A and 80B are connected to the base portion 421. Specifically, the limiters 70A and 70B are connected to respective ends of the connection portion 46 along the second direction Y, and the opposing portions 80A and 80B are connected to respective ends of the base portion 421 along the second direction Y.

Each of the limiters 70A and 70B is formed, for example, by bending a part of the connection portion 46. The opposing portions 80A and 80B are formed, for example, to be integrated with the base portion 421. In this case, the arrangement of the limiters 70A and 70B and the opposing portions 80A and 80B differs from that of the first embodiment. Specifically, along the third direction Z, the opposing portions 80A and 80B and the limiters 70A and 70B are arranged in this order.

Each of the limiters 70A and 70B includes a portion 71, a portion 73, and a portion 75, as shown in FIG. 13. The portion 71 is connected to the connection portion 46. Specifically, as shown in FIG. 13, the portion 71 of the limiter 70A extends from the connection portion 46 in the direction opposite to the second direction Y, while the portion 71 of the limiter 70B extends from the connection portion 46 in the second direction Y.

The portion 73, as shown in FIG. 13, is inclined relative to the first direction X in plan view. Specifically, the portion 73 of the limiter 70A extends, for example, in the direction opposite to the direction D2. Further, the portion 73 of the limiter 70B extends, for example, in the direction opposite to the direction D1.

The portions 73 of the limiters 70A and 70B are inclined such that they are spaced apart further from each other in plan view as the location advances in the first direction X. The distance W1 between two portions 73 adjacent to each other along the second direction Y increases as the location advances in the first direction X, as shown in FIG. 13.

Focusing on the opposing portions 80A and 80B, the portions 73 of the limiters 70A and 70B face the respective surfaces 413 of the opposing portions 80A and 80B with a respective gap G3 in the third direction Z therebetween, as shown in FIG. 14.

As shown in FIG. 14, the portions 73 of the limiters 70A and 70B each includes an edge portion 731 which face the respective one of the opposing portions 80A and 80B. In plan view, the edge portion 731 of the limiter 70A extends in the direction opposite to the direction D2, and the edge portion 731 of the limiter 70B extends in the direction opposite to the direction D1.

The portions 73 of the limiters 70A and 70B are provided substantially parallel to the opposing portions 80A and 80B, for example. Specifically, the edge portions 731 of the portions 73 of the limiters 70A and 70B are provided substantially parallel to the surfaces 413 of the opposing portions 80A and 80B, respectively.

The portion 75 connects the portion 71 and the portion 73 to each other. The portion 75 extends in a direction away from the load beam 30 (shown in FIG. 3). The portion 75 is configured such that the portions 73 are substantially parallel to the opposing portions 80A and 80B, respectively. The portion 75 extends in a direction different from those of the portion 71 and the portion 73. The portion 75 may be formed, for example, in a straight line or in an arc shape. Further, the portion 73 may be directly connected to the portion 71.

Moreover, focusing on the extending portions 700A and 700B, as shown in FIG. 15, the line L1A extends along the direction D2, and the line L1B extends along the direction D1. In this case, from the perspective of the mold 100 (shown in FIG. 10), the corner portion C1A of the die 101 extends along the direction D2, and the corner portion C1B of the die 101 extends along the direction D1. The corner portions C1A and C1B of the die 101 are inclined such that they are spaced apart further from each other as the location advances in the first direction X.

With the configuration of this embodiment, advantageous effects similar to those of the first embodiment can be obtained.

### Third Embodiment

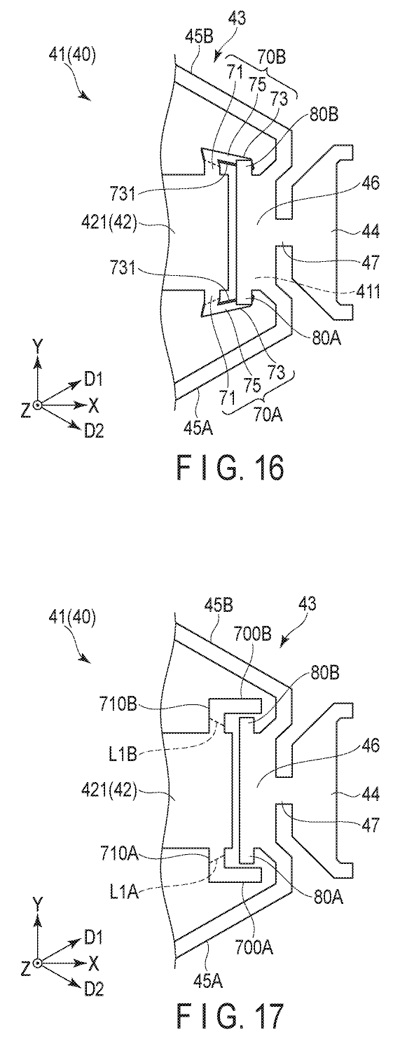

FIGS. 16 and 17 are schematic plan views each showing a metal base 41 of a flexure 40 according to this embodiment. This embodiment is different from the first embodiment in the configuration of the limiters 70A and 70B.

As shown in FIG. 17, the extending portions 700A and 700B have an approximately L-shaped shape in plan view. In this embodiment, as in the case of the first embodiment, the extending portions 700A and 700B are bent.

In this embodiment, the limiters 70A and 70B are configured such that the gap with respect to the opposing portions 80A and 80B increases as the location advances in the first direction X. Focusing on the portions 73, the edge portions 731 of the portions 73 are inclined to be spaced away further from the surfaces 411 of the opposing portions 80A and 80B, respectively, as the location advances in the first direction X. In this embodiment, the angles at which the lines L1A and L1B in FIG. 17 are inclined relative to the first direction X respectively correspond to the angles at which the edge portions 731 in FIG. 16 are inclined relative to the first direction X. The angles are, for example, from 0 degrees to 50 degrees.

With this embodiment as well, advantageous effects similar to those of the first embodiment can be obtained. Specifically, by inclining the portions 73 of the limiters 70A and 70B relative to the first direction X in plan view, the portions 73 can be inserted more inward with respect to the opposing portions 80A and 80B, respectively. With this configuration, the engagement lengths of the limiters 70A and 70B with respect to the opposing portions 80A and 80B can be made larger compared to those of the comparative example shown in FIG. 12.

### Fourth Embodiment

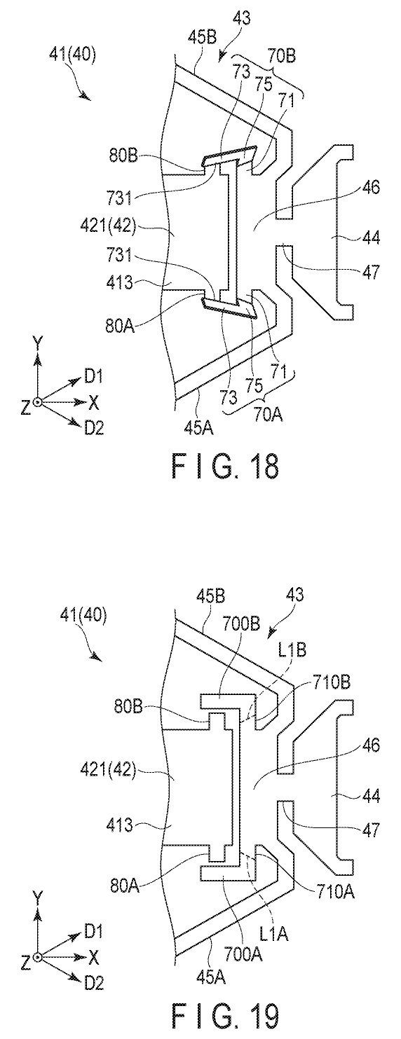

FIGS. 18 and 19 are schematic plan views each showing a metal base 41 of a flexure 40 according to this embodiment. This embodiment is different from the second embodiment in the configuration of the limiters 70A and 70B.

The extending portions 700A and 700B each have an approximately L-shaped configuration in plan view, as shown in FIG. 19. As in the second embodiment, the extending portions 700A and 700B are bent in this embodiment.

In this embodiment, the limiters 70A and 70B are configured such that the gap with respect to the opposing portions 80A and 80B decreases as the location advances in the first direction X. Focusing on the portions 73, the edge portions 731 of the portions 73 are inclined such that they approach the surfaces 413 of the opposing portions 80A and 80B, respectively, as the location advances in the first direction X. In this embodiment, the angles at which the lines L1A and L1B in FIG. 19 are inclined relative to the first direction X respectively correspond to the angles at which the edge portions 731 in FIG. 18 are inclined relative to the first direction X. The angles are, for example, from 0 degrees to 50 degrees.

In this embodiment as well, advantageous effect similar to those of the second embodiment can be obtained.

Further, as to the metal base 41 of the flexure 40 in each of the second to fourth embodiments, the manufacturing device 1000 and manufacturing method disclosed in the first embodiment can be applied as well. Note here that the configuration of the mold 100 can be appropriately modified according to the inclination of the lines L1A and L1B. Furthermore, in each of the above-provided embodiments, an example is disclosed in which the metal base 41 has two limiters, but the number of limiters is not limited to that of the examples described above.

In each of the above-provided embodiments, the surface 411 of the metal base 41 is one example of the first surface, the surface 413 of the metal base 41 is one example of the second surface, the limiters 70A and 70B are respective examples of the first limiter and the second limiter, and the opposing portions 80A and 80B are respective examples of the first opposing portion and the second opposing portion. Further, the portion 73 is one example of the control portion, the base portion 421 is one example of the first base portion, the connection portion 46 is one example of the second base portion, the fixation portion 44 is one example of the third base portion, the edge portion 731 is one example of the side portion, and the extending portions 700A and 700B are respective examples of the first extending portion and the second extending portion. Furthermore, the die 101 is one example of the first mold, the pad 103 is one example of the second mold, the punch 105 is one example of the third mold, and the corner portions C1A and C1B of the die 101 are respective examples of the first corner portion and the second corner portion.

In implementing each of the above-provided embodiments, the specific configurations of various elements constituting the hard disk device, including the load beam and flexure, can be modified in various ways.

Various embodiments can be formed by appropriately combining the multiple components disclosed in each of the above-provided embodiments. For example, some components may be omitted from the full set of components illustrated in each embodiment. Furthermore, components from different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flexure overlaid on a load beam of a suspension for a hard disk device, comprising:
a metal base including a first surface facing the load beam and a second surface on an opposite side to the first surface,
wherein
the metal base comprises:
a first limiter and a second limiter arranged along a width direction of the metal base; and
a first opposing portion and a second opposing portion facing the first limiter and the second limiter, respectively,
the first limiter and the second limiter include respective control portions inclined relative to a longitudinal direction of the metal base in plan view, which face the first opposing portion and the second opposing portion, respectively, with a gap therebetween in a thickness direction of the metal base.

2. The flexure of the suspension for the hard disk device, according to claim 1, wherein
the metal base further comprises:
a first base portion to which the first limiter and the second limiter are connected; and
a second base portion provided at a tip end side relative to the first base portion along the longitudinal direction, and a second base portion to which the first opposing portion and the second opposing portion are connected.

3. The flexure of the suspension for the hard disk device, according to claim 2, wherein
the control portion faces the first surface of the second base portion with a gap therebetween along the thickness direction.

4. The flexure of the suspension for the hard disk device, according to claim 3, wherein
the control portions of the first limiter and the second limiter are inclined such that, in plan view, they approach each other as a location thereon advances in the longitudinal direction.

5. The flexure of the suspension for the hard disk device, according to claim 1, wherein
the metal base further comprises:
a first base portion to which the first opposing portion and the second opposing portion are connected; and
a second base portion provided at a tip end side relative to the first base portion along the longitudinal direction, to which the first limiter and the second limiter are connected.

6. The flexure of the suspension for the hard disk device, according to claim 5, wherein
the control portion faces the second surface of the first base portion with a gap therebetween along the thickness direction.

7. The flexure of the suspension for the hard disk device, according to claim 6, wherein
the control portions of the first limiter and the second limiter are inclined such that, in plan view, they are spaced apart further from each other as the location advances in the longitudinal direction.

8. The flexure of the suspension for the hard disk device, according to claim 1, wherein
each of respective distances along the thickness direction between the first limiter and the second limiter and the first opposing portion and the second opposing portion is substantially constant along the longitudinal direction when viewed in the width direction.

9. The flexure of the suspension for the hard disk device, according to claim 8, wherein
the control portions include respective side portions substantially parallel to the first opposing portion and the second opposing portion, respectively.

10. The flexure of the suspension for the hard disk device, according to claim 2, wherein
the metal base further has a third base portion provided at a tip end side relative to the second base portion, connected to the second base portion, and fixed to the load beam.

11. The flexure of the suspension for the hard disk device, according to claim 5, wherein
the metal base further has a third base portion provided at a tip end side relative to the second base portion, connected to the second base portion, and fixed to the load beam.

12. A method for manufacturing the flexure according to claim 1, the method comprising:
placing a workpiece including a first extending portion and a second extending portion extending in a width direction for the first limiter and the second limiter, respectively, in a first mold including a first corner portion and a second corner portion inclined relative to the longitudinal direction in plan view;
fixing the workpiece by sandwiching between the first mold and the second mold; and
relatively moving a third mold with respect to the first mold and the second mold, and bending the first extending portion and the second extending portion by the first corner portion and the second corner portion,
wherein
the placing including adjusting positions of the first corner portion and the second corner portion relative to the first extending portion and the second extending portion along the width direction.

13. The manufacturing method according to claim 12, wherein
the adjusting includes moving the workpiece relative to the first mold along the longitudinal direction.
